(19) United States
(12) Patent Application Publication
(10) Pub. No.: US 2022/0398653 A1
(43) Pub. Date: Dec. 15, 2022

(54) INFORMATION PROCESSING DEVICE, INFORMATION PROCESSING METHOD, AND NON-TRANSITORY STORAGE MEDIUM

(71) Applicant: Toyota Jidosha Kabushiki Kaisha, Toyota-shi (JP)

(72) Inventors: Naoya Oka, Nagakute-shi (JP); Satoshi Kitamura, Nagoya-shi (JP); Yusuke Sobue, Nagoya-shi (JP); Seira Nakada, Nagoya-shi (JP); Mami Mori, Nagoya-shi (JP); Masato Morishima, Nagoya-shi (JP); Yasuyuki Nunokawa, Nagoya-shi (JP)

(73) Assignee: Toyota Jidosha Kabushiki Kaisha, Toyota-shi (JP)

(21) Appl. No.: 17/832,803

(22) Filed: Jun. 6, 2022

(30) Foreign Application Priority Data
Jun. 14, 2021 (JP) 2021-098545

(51) Int. Cl. G06Q 30/06

(52) U.S. Cl. CPC G06Q 30/0645

(57) ABSTRACT

An information processing device includes a processor. The processor is configured to providing a second service online, the second service being a service related to temporary use of a specific vehicle rented to a first user who is a user of a first service, the first service being a vehicle rental service. The processor is also configured to generate proposal information for proposing use of a third service to a second user who temporarily uses the specific vehicle by using the second service, the third service being a service related to movement.

### CROSS-REFERENCE TO RELATED APPLICATION

This application claims priority to Japanese Patent Application No. 2021-098545 filed on Jun. 14, 2021, incorporated herein by reference in its entirety.

### BACKGROUND

### 1. Technical Field

The present disclosure relates to information processing devices, information processing methods, and non-transitory storage media.

### 2. Description of Related Art

Japanese Unexamined Patent Application Publication No. 2014-127077 (JP 2014-127077 A) discloses an incentive providing device. The incentive providing device disclosed in JP 2014-127077 A advertises the existence of a second game to an existing user while the existing user is playing a first game, and thus encourages the existing user to play the second game. The incentive providing device issues a referral code for referring new users to the second game, while the existing user is playing the second game. The incentive providing device provides a predetermined incentive to the first game the existing user plays when a new user the existing user referred downloads the second game.

### SUMMARY

The present disclosure provides a technique that is effective in efficiently encouraging a user to use a service related to movement.

A first aspect of the present disclosure relates to an information processing device including a processor. The processor is configured to provide a second service online, the second service being a service related to temporary use of a specific vehicle rented to a first user who is a user of a first service, the first service being a vehicle rental service. The processor is also configured to generate proposal for information proposing use of a third service to a second user who temporarily uses the specific vehicle by using the second service, the third service being a service related to movement.

In the first aspect, the first service may be a service that gives the first user a right to use the specific vehicle for a predetermined period in exchange for regular payments of a usage fee for the first service.

In the first aspect, the second service may be a first platform service that carries out a substitute procedure for temporarily renting out the specific vehicle to the second user during the predetermined period online.

In the first aspect, the third service may be a second platform service that performs at least one of carrying out a procedure for starting use of the first service, providing information on movement, and carrying out a substitute procedure related to movement.

In the first aspect, the processor may be configured to provide to the first user an incentive about at least one of the first service and a third platform service that provides the information on movement or that carries out the substitute procedure related to movement, when the second user uses the third service.

In the first aspect, the processor may be configured to provide an incentive for the third service to the second user when the second user uses the third service.

In the first aspect, the processor may be configured to generate the proposal information based on a usage record of the second service by the second user.

In the first aspect, the processor may be configured to generate the proposal information based on an attribute of the specific vehicle.

In the first aspect, the processor may be configured to generate the proposal information based on a preference of the second user.

A second aspect of the present disclosure relates to an information processing method. The information processing method includes: providing a second service online, the second service being a service related to temporary use of a specific vehicle rented to a first user who is a user of a first service, the first service being a vehicle rental service; and generating proposal information for proposing use of a third service to a second user who temporarily uses the specific vehicle by using the second service, the third service being a service related to movement.

In the second aspect, the first service may be a service that gives the first user a right to use the specific vehicle for a predetermined period in exchange for regular payments of a usage fee for the first service.

In the second aspect, the second service may be a first platform service that carries out a substitute procedure for temporarily renting out the specific vehicle to the second user during the predetermined period online.

In the second aspect, the third service may be a second platform service that performs at least one of carrying out a procedure for starting use of the first service, providing information on movement, and carrying out a substitute procedure related to movement.

In the second aspect, the information processing method may further include providing to the first user an incentive about at least one of the first service and a third platform service that provides the information on movement or that carries out the substitute procedure related to movement, when the second user uses the third service.

In the second aspect, the information processing method may further include providing an incentive for the third service to the second user when the second user uses the third service.

In the second aspect, the proposal information may be generated based on a usage record of the second service by the second user.

In the second aspect, the proposal information may be generated based on an attribute of the specific vehicle.

In the second aspect, the proposal information may be generated based on a preference of the second user.

A third aspect of the present disclosure relates to a non-transitory storage medium storing instructions that are executable by one or more processors and that cause the one or more processors to perform functions. The functions include: providing a second service online, the second service being a service related to temporary use of a specific vehicle rented to a first user who is a user of a first service, the first service being a vehicle rental service; and generating proposal information for proposing use of a third service to a second user who temporarily uses the specific vehicle by using the second service, the third service being a service related to movement.

In the third aspect, the first service may be a service that gives the first user a right to use the specific vehicle for a predetermined period in exchange for regular payments of a usage fee for the first service.

According to the first, second, and third aspects of the present disclosure, it is possible to provide a technique that is effective in efficiently encouraging a user to use a service related to movement.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 shows a schematic configuration of a proposal system;

FIG. 2 is a block diagram schematically showing an example of a functional configuration of a management server;

FIG. 3 shows an example of a table configuration of vehicle information stored in a vehicle information database;

FIG. 4 shows an example of a table configuration of user information stored in a user information database;

FIG. 5 shows an example of a table configuration of service information stored in a service information database;

FIG. 6 is a flowchart of a proposal process; and

FIG. 7 is a flowchart of a provision process.

### DETAILED DESCRIPTION OF EMBODIMENTS

The first aspect of the present disclosure relates to the information processing device. The information processing device is a device that performs information processing related to the first service. The first service is a vehicle rental service. The first service is, for example, a service that gives a user the right to use a vehicle for a contract period in exchange for regular (e.g., monthly or yearly) fee payments from the user. Such a service is also called “lease” or “subscription.” The first user is a user of the first service. The first user rents the specific vehicle by using the first service. There are cases where the first user lets the second user temporarily use the specific vehicle rented to the first user. Accordingly, the processor of the information processing device provides the second service related to the temporary use of the specific vehicle online.

The user who temporarily uses the specific vehicle using the second service is a user who moves by the specific vehicle. The user who temporarily uses the specific vehicle using the second service is therefore a potential user of the service related to movement (hereinafter sometimes referred to as “third service”). Accordingly, the processor of the information processing device provides the proposal information proposing the use of the third service to the second user who temporarily uses the specific vehicle using the second service. The third service is, for example, a platform service that provides information on movement or that carries out a procedure related to movement on behalf of the user. The third service may be a platform service that carries out a procedure for starting the use of the first service on behalf of the user. In this case, the second user uses the third service to carry out the procedure for starting the use of the first service. A vehicle is thus rented to the second user through the first service, so that the second user can move by the vehicle.

As described above, the information processing device provides the proposal information proposing the use of the third service to a potential user of the third service. As a result, it is possible to efficiently encourage the user to use the service related to movement.

Specific embodiments of the present disclosure will be described below with reference to the drawings. The dimensions, materials, shapes, relative arrangements, etc. of components described in the embodiments are not intended to limit the technical scope of the present disclosure to those dimensions, materials, shapes, relative arrangements, etc. unless otherwise specified.

### First Embodiment

### System Overview

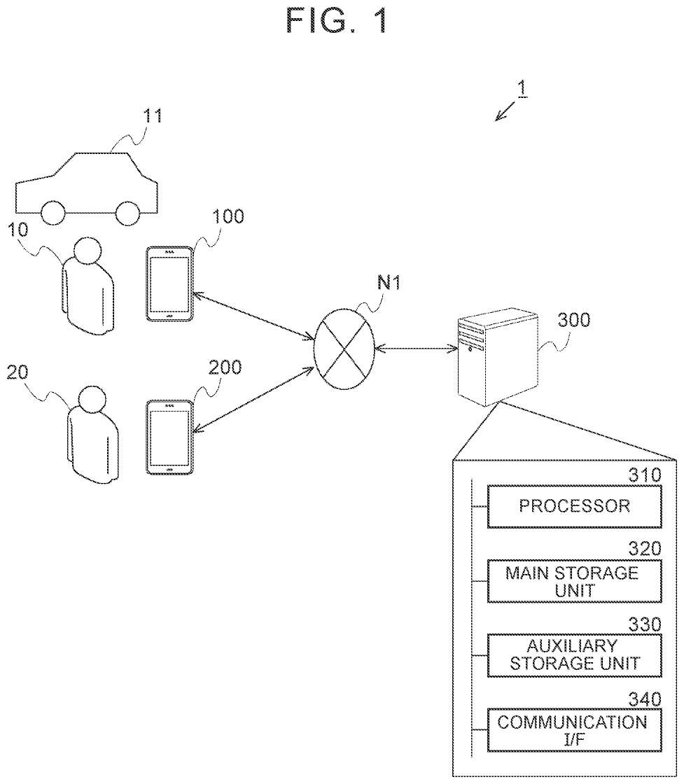

A proposal system 1 of the present embodiment will be described with reference to FIG. 1. FIG. 1 shows a schematic configuration of the proposal system 1. The proposal system 1 includes a first terminal 100, a second terminal 200, and a management server 300. In the proposal system 1, the first terminal 100, the second terminal 200, and the management server 300 are connected to each other via a network N1. For example, the network N1 may be a wide area network (WAN) that is a world-wide public communication network such as the Internet, or a telephone communication network for mobile phones etc.

### First Terminal

The first terminal 100 is a terminal used by a first user 10. The first terminal 100 is, for example, a computer or a personal digital assistant. The first user 10 is a user of a rental service. The rental service is a service that allows the first user 10 to register with a public institution as a user of a specific vehicle 11 for a contract period in exchange for monthly usage fee payments from the first user 10. The first user 10 can choose the contract period of the rental service from a plurality of periods determined by a provider of the rental service (e.g., 3 years, 5 years, and 7 years). Such a rental service is sometimes called “lease” or “subscription.” The rental service in the present embodiment is an example of the “first service” according to the present disclosure.

The first terminal 100 in the present embodiment has a function to implement interaction related to a temporary use service. For example, the first terminal 100 implements a function to present, to the first user 10, input fields required for a contract that allows the first user 10 to let a second user 20 temporarily use the specific vehicle 11. The first terminal 100 also implements a function to accept the first user 10's operation of entering the input fields and a function to send information entered by the first user 10 to the management server 300. These functions are implemented by, for example, a web browser running on the first terminal 100. These functions may be implemented by, for example, an application program installed on the first terminal 100. The term “temporary use” herein means that the first user 10 who is using the rental service lets the second user 20 temporarily use the rented specific vehicle 11. That is, the first user 10 temporarily rents out the rented specific vehicle 11 to the second user 20. Such temporary use is established by a contract between the first user 10 and the second user 20, and contracting procedures for the temporary use are carried out using the temporary use service. The temporary use service is an online platform service provided by the management server 300. The temporary use service in the present embodiment is an example of the “second service” according to the present disclosure.

### Second Terminal

The second terminal 200 is a terminal used by the second user 20. The second user 20 is a user who temporarily uses the specific vehicle 11 rented to the first user 10. The second terminal 200 has a function to implement interaction related to the temporary use of the specific vehicle 11. For example, the second terminal 200 implements a function to present, to the second user 20, input fields required for a contract that allows the second user 20 to temporarily use the specific vehicle 11 rented to the first user 10. The second terminal 200 also implements a function to accept the second user 20's operation of entering the input fields and a function to send information entered by the second user 20 to the management server 300. These functions are implemented by, for example, a web browser in which the temporary use service can be used, or an application program.

### Management Server

The management server 300 is a server device that performs information processing related to the rental service. The management server 300 has a function to manage the rental status of the specific vehicle 11. The management server 300 has a function to manage the temporary use of the specific vehicle 11. For example, the management server 300 further has a function to cause the contracting procedures for the temporary use of the specific vehicle 11 between the first user 10 and the second user 20 to be carried out online. The management server 300 further has a function to propose the use of a service related to movement (hereinafter sometimes referred to as “specific service”) to the second user 20 who temporarily uses the specific vehicle 11.

The user who temporarily uses the vehicle using the temporary use service is a user who moves by the vehicle. Therefore, the user who temporarily uses the vehicle using the temporary use service is a potential user of the specific service. The management server 300 provides proposal information proposing the use of the specific service to the second user 20 who temporarily uses the specific vehicle 11 using the temporary use service. The specific service is, for example, a platform service that provides information on movement. In this case, the specific service provides a service that introduces a spot the user is going to visit. The specific service may be a platform service that carries out procedures related to movement on behalf of the user. In this case, the specific service provides, for example, a service that makes a reservation for the spot the user is going to visit on behalf of the user.

The specific service may be a platform service that carries out procedures for starting the use of the rental service on behalf of the user. The second user 20 uses the specific service to carry out the procedures for starting the use of the rental service. A vehicle is thus rented to the second user 20 through the rental service, so that the second user 20 can move by the vehicle.

The management server 300 includes a computer that includes a processor 310, a main storage unit 320, an auxiliary storage unit 330, and a communication interface (communication I/F) 340. The processor 310 is, for example, a central processing unit (CPU) or a digital signal processor (DSP). The main storage unit 320 is, for example, a random access memory (RAM). The auxiliary storage unit 330 is, for example, a read-only memory (ROM). Alternatively, the auxiliary storage unit 330 is, for example, a hard disk drive (HDD) or a disc recording medium such as compact disc read-only memory (CD-ROM), digital versatile disc (DVD), or Blu-ray disc. The auxiliary storage unit 330 may be a removable medium (portable recording medium). Examples of the removable medium include a Universal Serial Bus (USB) memory and a Secure Digital (SD) card. The communication I/F 340 is, for example, a local area network (LAN) interface board or a wireless communication circuit for wireless communication.

The auxiliary storage unit 330 of the management server 300 stores an operating system (OS), various programs, various information tables, etc. The management server 300 can implement such various functions as will be described later by the processor 310 loading the programs stored in the auxiliary storage unit 330 into the main storage unit 320 and executing the programs. However, a part or all of the functions of the management server 300 may be implemented by a hardware circuit such as application-specific integrated circuit (ASIC) or field-programmable gate array (FPGA). The management server 300 need not necessarily be implemented by a single physical configuration, and may be configured by a plurality of computers that cooperates with each other. The management server 300 in the present embodiment is an example of “the information processing device” according to the present disclosure. Like the management server 300, the first terminal 100 and the second terminal 200 also include a computer.

### Functional Configuration

Next, the functional configuration of the management server 300 constituting the proposal system 1 according to the present embodiment will be described with reference to FIGS. 2 to 5. FIG. 2 is a block diagram schematically showing an example of the functional configuration of the management server 300.

The management server 300 includes a control unit 301, a communication unit 302, a vehicle information database 303 (vehicle information DB 303), a user information database 304 (user information DB 304), and a service information database 305 (service information DB 305). The control unit 301 has a function to perform arithmetic calculations for controlling the management server 300. The control unit 301 can be implemented by the processor 310 in the management server 300. The communication unit 302 has a function to connect the management server 300 to the network N1. The communication unit 302 can be implemented by the communication I/F 340 in the management server 300.

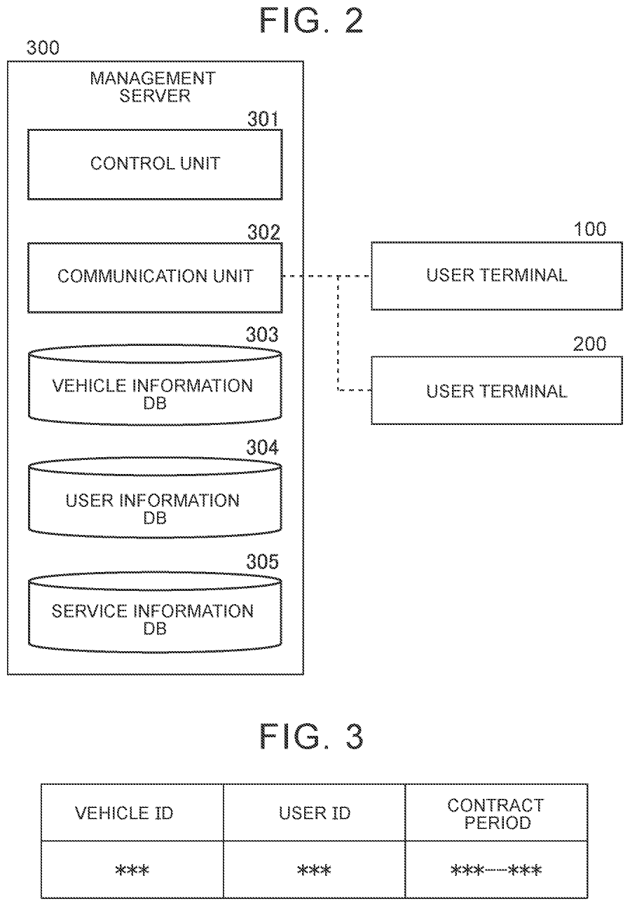

The vehicle information DB 303 has a function to store vehicle information. The vehicle information DB 303 can be implemented by the auxiliary storage unit 330 in the management server 300. The vehicle information is information on the rental status of the specific vehicle 11 in the rental service. FIG. 3 shows an example of a table configuration of the vehicle information stored in the vehicle information DB 303. As shown in FIG. 3, the vehicle information includes a vehicle identification (ID) field, a user ID field, and a contract period field. An identifier (vehicle ID) identifying the specific vehicle 11 is input to the vehicle ID field. An identifier (user ID) identifying the first user 10 is input to the user ID field. A contract period for which the specific vehicle 11 is rented to the first user 10 is input to the contract period field. The management server 300 can manage the rental status of the specific vehicle 11 in the rental service as the vehicle information including the vehicle ID, the user ID, and the contract period is stored in the vehicle information DB 303 as described above.

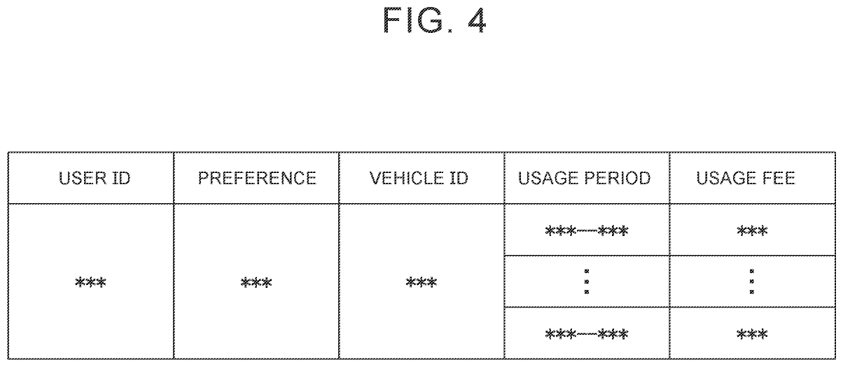

The user information DB 304 has a function to store user information. The user information DB 304 can be implemented by the auxiliary storage unit 330 in the management server 300. The user information is information on the status of temporary use of the specific vehicle 11 in the temporary use service. FIG. 4 shows an example of a table configuration of the user information stored in the user information DB 304. As shown in FIG. 4, the user information includes a user ID field, a preference field, a vehicle ID field, a usage period field, and a usage fee field.

An identifier (user ID) identifying the second user 20 is input to the user ID field. Information on preference of the second user 20 is input to the preference field. Information on preference of the second user 20 sent in advance from the second user 20 to the management server 300 using the second terminal 200 is input to the preference field. For example, the second user 20's preferred service or product is input to the preference field as the preference of the second user 20. The management server 300 can thus be aware of the preference of the second user 20. The vehicle ID of the specific vehicle 11 is input to the vehicle ID field. A period for which the second user 20 temporarily uses the specific vehicle 11 using the temporary use service is input to the usage period field. A usage fee paid from the second user 20 to the first user 10 for the temporary use of the specific vehicle 11 for the usage period is input to the usage fee field.

The control unit 301 is configured to implement a Web server that provides the temporary use service. For example, the control unit 301 implements a Web server that interacts with the first terminal 100. In that case, the first terminal 100 can access the Web server via a browser to present to the first user 10 the input fields required for the contract that allows the first user 10 to let the second user 20 temporarily use the specific vehicle 11. The first terminal 100 can also upload information entered by the first user 10 for the contract that allows the first user 10 to let the second user 20 temporarily use the specific vehicle 11 (hereinafter sometimes referred to as “first information”) to the Web server via the browser. The control unit 301 also implements a Web server that interacts with the second terminal 200. In that case, the second terminal 200 can access the Web server via a browser to present to the second user 20 the input fields required for the contract that allows the second user 20 to temporarily use the specific vehicle 11. The second terminal 200 can also upload information entered by the second user 20 for the contract that allows the second user 20 to temporarily use the specific vehicle 11 (hereinafter sometimes referred to as “second information”) to the Web server via the browser.

The control unit 301 carries out contracting procedures between the first user 10 and the second user 20 on behalf of the first user 10 and the second user 20, based on the first information and second information uploaded to the management server 300. Specifically, the control unit 301 sends contract information to the first terminal 100 and the second terminal 200 based on the first information and the second information. The contract information is information indicating the contents of the contract for a temporary rental of the specific vehicle 11 between the first user 10 and the second user 20.

Upon completion of the contracting procedures between the first user 10 and the second user 20, the control unit 301 performs a process of charging the second user 20 a fee for the temporary use of the specific vehicle 11. The control unit 301 may charge the fee when the second user 20's temporary use of the specific vehicle 11 ends (when the specific vehicle 11 is returned from the second user 20 to the first user 10). Upon completion of the contracting procedures between the first user 10 and the second user 20, the control unit 301 updates the user information stored in the user information DB 304. Specifically, the control unit 301 updates the registered information in the usage period field and usage fee field of the user information, based on the usage period and usage fee defined by the contracting procedures. The second user 20 can thus be aware of the latest usage status of the temporary use service.

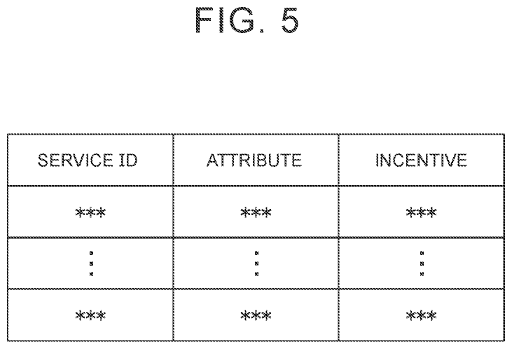

The service information DB 305 has a function to store service information. The service information DB 305 can be implemented by the auxiliary storage unit 330 in the management server 300. The service information is information on the specific service. FIG. 5 shows an example of a table configuration of the service information stored in the service information DB 305. As shown in FIG. 5, the service information includes a service ID field, an attribute field, and an incentive field.

An identifier (service ID) identifying the specific service is input to the service ID field. Information on an attribute of the specific service in the service ID field is input to the attribute field. A service or product provided by the specific service is input to the attribute field as the attribute of the specific service.

Information on an incentive to be provided to the first user 10 when the second user 20 uses the specific service in the service ID field is input to the incentive field. The incentive to be provided to the first user 10 is, for example, an incentive for either or both of the rental service the first user 10 is using and the platform service that provides information on movement or that carries out procedures related to movement on behalf of the user. The incentive to be provided to the first user 10 is, for example, a discount on the usage fee of these services. The incentive to be provided to the first user 10 may be different for each specific service used by the second user 20. As described above, the service information DB 305 stores the service information in which the attribute of the specific service and the information on the incentive to be provided to the first user 10 when the second user 20 uses the specific service are associated with each other.

### Proposal Process

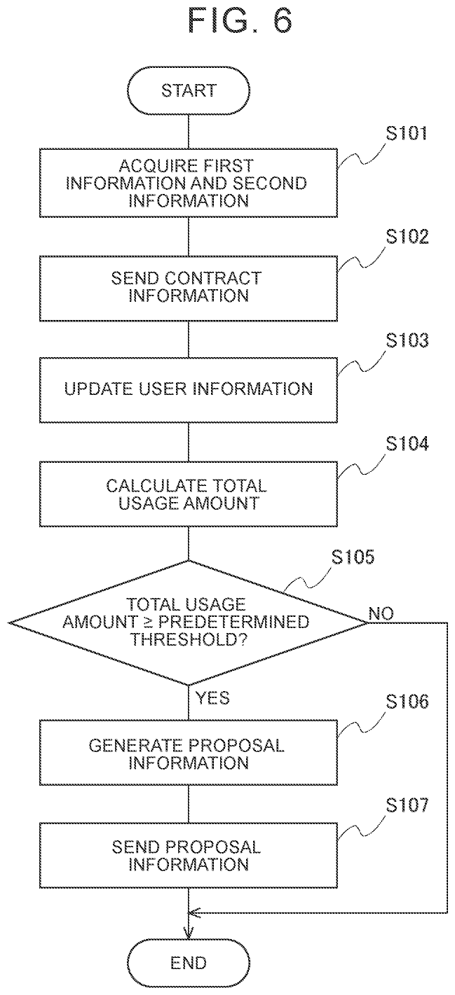

Next, a proposal process that is performed by the control unit 301 of the management server 300 of the proposal system 1 according to the present embodiment will be described with reference to FIG. 6. FIG. 6 is a flowchart of the proposal process. The proposal process is a process of sending the proposal information to the second terminal 200. The control unit 301 starts the proposal process when the first information and the second information are uploaded to the management server 300.

In the proposal process, the control unit 301 first acquires the first information and the second information in S101. In S102, the control unit 301 then generates contract information based on the first information and the second information and sends the contract information to the first terminal 100 and the second terminal 200. The control unit 301 thus completes the contracting procedures between the first user 10 and the second user 20 on behalf of the first user 10 and the second user 20. In S103, the control unit 301 then updates the user information stored in the user information DB 304. Thereafter, in S104, the control unit 301 calculates the total amount of the usage fees that the second user 20 has paid to the first user 10 (hereinafter sometimes referred to as “total usage amount”), based on the updated user information.

Subsequently, the control unit 301 determines in S105 whether the total usage amount is equal to or greater than a predetermined threshold. The predetermined threshold is set to a value from which it can be determined that the second user 20 likes to use the temporary use service. When YES in S105, the control unit 301 generates proposal information in S106. The control unit 301 generates the proposal information based on the user information stored in the user information DB 304 and the service information stored in the service information DB 305. Specifically, the control unit 301 generates proposal information proposing the use of the specific service in the service information whose attribute matches the information on the preference of the second user 20 in the user information. The control unit 301 can thus propose a specific service suitable for the second user 20.

The proposal information generated in S106 may include information proposing the use of the platform service that carries out procedures for starting the use of the rental service on behalf of the user. This configuration makes it possible to encourage the second user 20 who has spent a lot of money to rent the specific vehicle 11 to use the rental service instead of the temporary use service.

When the control unit 301 generates the proposal information in S106, the control unit 301 sends it to the second terminal 200 in S107. The proposal process thus ends. When NO in S105, the proposal process ends. That is, the control unit 301 does not send the proposal information to the second terminal 200.

As described above, the proposal information is sent when the total usage amount is equal to or greater than the predetermined threshold. Accordingly, the proposal information is sent to the second terminal 200 when the second user 20 has spent the predetermined amount of money or more for the temporary use service. This configuration makes it possible to encourage the second user 20 who likes to temporarily use the specific vehicle 11 for movement to use the specific service. As a result, it is possible to efficiently encourage the user to use the service related to movement.

### Modifications

In the above embodiment, the management server 300 generates proposal information and sends it to the second terminal 200 when the total usage amount is equal to or greater than the predetermined threshold. However, the management server 300 need not necessarily generate proposal information and sends it to the second terminal 200 when the total usage amount is equal to or greater than the predetermined threshold. For example, the management server 300 may generate proposal information and send it to the second terminal 200 when the second user 20 has used the temporary use service a predetermined number of times or more. In this case, the management server 300 acquires the number of times the second user 20 has used the temporary use service based on the user information, and determines whether the second user 20 has used the temporary use service the predetermined number of times or more. This configuration also makes it possible to encourage the second user 20 who likes to temporarily use the specific vehicle 11 for movement to use the specific service.

The management server 300 may generate proposal information and send it to the second terminal 200 without performing the step of determining whether the total usage amount is equal to or greater than the predetermined threshold (S105) in the proposal process. That is, the management server 300 may not perform the determination step S105 and may send proposal information when the contracting procedures between the first user 10 and the second user 20 are completed. This configuration also makes it possible to efficiently encourage the user to use the service related to movement.

In the above embodiment, the management server 300 generates proposal information based on the preference of the second user 20. However, the management server 300 need not necessarily generate proposal information based on the preference of the second user 20. The management server 300 may generate proposal information proposing the use of a predetermined specific service and send it to the second terminal 200. Alternatively, the management server 300 may determine proposal information based on an attribute of the specific vehicle 11 the second user 20 temporarily uses, instead of based on the preference of the second user 20. In this case, the vehicle information stored in the vehicle information DB 303 is information that further includes information on the attribute of the specific vehicle 11. The attribute of the specific vehicle 11 is, for example, the name, make, model, type, color, year, etc. of the specific vehicle 11. The management server 300 acquires a service attribute that the user who uses the specific vehicle 11 tends to like, based on the attribute of the specific vehicle 11. The management server 300 generates proposal information based on the acquired service attribute and the attribute of each specific service in the service information stored in the service information DB 305. The management server 300 can thus propose a specific service suitable for the second user 20 who temporarily uses the specific vehicle 11.

### Second Embodiment

In the present embodiment, an incentive is provided to the first user 10 when the second user 20 uses the specific service. Only the differences from the first embodiment will be described below.

When the second terminal 200 receives proposal information from the management server 300, the second terminal 200 displays the proposal information on the display of the second terminal 200. When the second user 20 uses the specific service proposed in the proposal information, the second user 20 applies for the specific service using the second terminal 200. When the second user 20 completes the application for the specific service using the second terminal 200, the second terminal 200 sends application information to the management server 300. The application information includes information on the application made by the second user 20 for the specific service.

### Providing Process

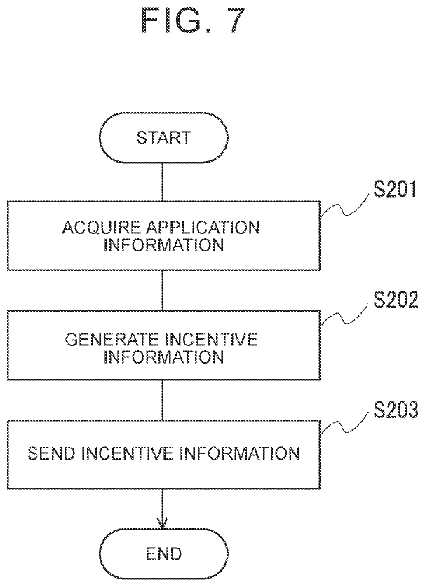

A providing process that is performed by the control unit 301 of the management server 300 of the proposal system 1 according to the present embodiment will be described with reference to FIG. 7. FIG. 7 is a flowchart of the providing process. The providing process is a process of providing an incentive to the first user 10 by sending incentive information to the first terminal 100. The control unit 301 starts the providing process when it receives the application information from the second terminal 200 via the communication unit 302.

In the providing process, the control unit 301 first acquires the application information in S201. Specifically, the control unit 301 acquires the service ID of the specific service for which the second user 20 has applied, based on the application information. Next, the control unit 301 generates incentive information in S202. Specifically, the control unit 301 acquires the incentive corresponding to the acquired service ID from the incentive field of the service information stored in the service information DB 305. The control unit 301 then generates incentive information. The control unit 301 sends the incentive information to the first terminal 100 in S203. The providing process thus ends.

As described above, an incentive is provided to the first user 10 when the second user 20 uses the specific service. Accordingly, the more the first user 10 let the second user 20 temporarily use the specific vehicle 11 using the temporary use service, the more opportunities the first user 10 has to receive the incentive. The first user 10 is therefore encouraged to let the second user 20 temporarily use the specific vehicle 11 using the temporary use service. As a result, the second user 20 will have more opportunities to temporarily use the specific vehicle 11. Accordingly, the second user 20 will move more often and will have more opportunities to use the specific service. This configuration thus makes it possible to efficiently encourage the second user 20 to use the specific service.

### Modifications

In the above embodiment, the management server 300 provides an incentive to the first user 10. The management server 300 may provide an incentive for the specific service to the second user 20 when the second user 20 uses the specific service. The incentive for the specific service is, for example, an incentive for the specific service used by the second user 20. When the second user 20 starts using the rental service by using the specific service, the incentive to be provided to the second user 20 may be a discount on the usage fee for the rental service. The incentive to be provided to the second user 20 may be a discount on the usage fee for the platform service used by the second user 20 that provides information on movement or that carries out procedures related to movement on behalf of the user. It is thus possible to encourage the second user 20 to use the specific service. This configuration also makes it possible to efficiently encourage the user to use the service related to movement.

### Other Embodiments

The above embodiments are merely illustrative, and the present disclosure may be modified as appropriate without departing from the spirit and scope of the present disclosure. For example, the processes and means described in the present disclosure may be combined as desired unless technical contradiction occurs.

The process described as being performed by a single device may be divided into a plurality of parts and performed by a plurality of devices. Alternatively, the processes described as being performed by different devices may be performed by a single device. In a computer system, the hardware configuration (server configuration) that implements functions can be flexibly changed.

The present disclosure can also be implemented by supplying computer programs that implement the functions described in the above embodiments to a computer and causing one or more processors of the computer to read and execute the computer programs. Such computer programs may be provided to the computer by a non-transitory computer-readable storage medium that can be connected to a system bus of the computer, or may be provided to the computer via a network. Examples of the non-transitory computer-readable storage medium include: any type of disk or disc such as a magnetic disk (floppy (registered trademark) disk, hard disk drive (HDD), etc.) and an optical disc (CD-ROM, digital versatile disc (DVD), Blu-ray disc, etc.); and any type of medium suitable for storing electronic instructions such as a read-only memory (ROM), a random access memory (RAM), an erasable programmable ROM (EPROM), an electrically erasable programmable ROM (EEPROM), a magnetic card, a flash memory, and an optical card.

What is claimed is:

1. An information processing device comprising a processor, the processor being configured to:
provide a second service online, the second service being a service related to temporary use of a specific vehicle rented to a first user who is a user of a first service, the first service being a vehicle rental service; and
generate proposal information for proposing use of a third service to a second user who temporarily uses the specific vehicle by using the second service, the third service being a service related to movement.

2. The information processing device according to claim 1, wherein the first service is a service that gives the first user a right to use the specific vehicle for a predetermined period in exchange for regular payments of a usage fee for the first service.

3. The information processing device according to claim 2, wherein the second service is a first platform service that carries out a substitute procedure for temporarily renting out the specific vehicle to the second user during the predetermined period online.

4. The information processing device according to claim 2, wherein the third service is a second platform service that performs at least one of carrying out a procedure for starting use of the first service, providing information on movement, and carrying out a substitute procedure related to movement.

5. The information processing device according to claim 4, wherein the processor is configured to provide, to the first user, an incentive about at least one of the first service and a third platform service that provides the information on movement or that carries out the substitute procedure related to movement, when the second user uses the third service.

6. The information processing device according to claim 4, wherein the processor is configured to provide an incentive for the third service to the second user when the second user uses the third service.

7. The information processing device according to claim 1, wherein the processor is configured to generate the proposal information based on a usage record of the second service by the second user.

8. The information processing device according to claim 1, wherein the processor is configured to generate the proposal information based on an attribute of the specific vehicle.

9. The information processing device according to claim 1, wherein the processor is configured to generate the proposal information based on a preference of the second user.

10. An information processing method comprising:
providing a second service online, the second service being a service related to temporary use of a specific vehicle rented to a first user who is a user of a first service, the first service being a vehicle rental service; and
generating proposal information for proposing use of a third service to a second user who temporarily uses the specific vehicle by using the second service, the third service being a service related to movement.

11. The information processing method according to claim 10, wherein the first service is a service that gives the first user a right to use the specific vehicle for a predetermined period in exchange for regular payments of a usage fee for the first service.

12. The information processing method according to claim 11, wherein the second service is a first platform service that carries out a substitute procedure for temporarily renting out the specific vehicle to the second user during the predetermined period online.

13. The information processing method according to claim 11, wherein the third service is a second platform service that performs at least one of carrying out a procedure for starting use of the first service, providing information on movement, and carrying out a substitute procedure related to movement.

14. The information processing method according to claim 13, further comprising providing to the first user an incentive about at least one of the first service and a third platform service that provides the information on movement or that carries out the substitute procedure related to movement, when the second user uses the third service.

15. The information processing method according to claim 13, further comprising providing an incentive for the third service to the second user when the second user uses the third service.

16. The information processing method according to claim 10, wherein the proposal information is generated based on a usage record of the second service by the second user.

17. The information processing method according to claim 10, wherein the proposal information is generated based on an attribute of the specific vehicle.

18. The information processing method according to claim 10, wherein the proposal information is generated based on a preference of the second user.

19. A non-transitory storage medium storing instructions that are executable by one or more processors and that cause the one or more processors to perform functions comprising:
providing a second service online, the second service being a service related to temporary use of a specific vehicle rented to a first user who is a user of a first service, the first service being a vehicle rental service; and
generating proposal information for proposing use of a third service to a second user who temporarily uses the specific vehicle by using the second service, the third service being a service related to movement.

20. The non-transitory storage medium according to claim 19, wherein the first service is a service that gives the first user a right to use the specific vehicle for a predetermined period in exchange for regular payments of a usage fee for the first service.
